(19) United States
(12) Patent Application Publication
(10) Pub. No.: US 2025/0019808 A1
(43) Pub. Date: Jan. 16, 2025

(54) HOT-ROLLED STEEL SHEET

(71) Applicant: NIPPON STEEL CORPORATION, Tokyo (JP)

(72) Inventors: Mutsumi SAKAKIBARA, Tokyo (JP); Hiroshi SHUTO, Tokyo (JP); Hiroshi TANEI, Tokyo (JP)

(73) Assignee: NIPPON STEEL CORPORATION, Tokyo (JP)

(21) Appl. No.: 18/714,459

(22) PCT Filed: Dec. 6, 2022
(86) PCT No.: PCT/JP2022/044816

§ 371 Date: May 29, 2024

(30) Foreign Application Priority Data
Dec. 15, 2021 (JP) 2021-203094

(51) Int. Cl. C22C 38/06; C21D 8/02; C21D 9/46; C22C 38/02; C22C 38/04

(52) U.S. Cl. CPC C22C 38/06; C21D 8/0205; C21D 8/0226; C21D 9/46; C22C 38/02; C22C 38/04; C21D 2211/001; C21D 2211/002; C21D 2211/005; C21D 2211/008; C21D 2211/009

(57) ABSTRACT

This hot-rolled steel sheet has a microstructure comprising bainite: 55 to 95%, retained austenite: 5 to 30%, fresh martensite: 5% or less, ferrite: 5% or less, and pearlite: 5% or less, in a texture at a region from a surface to a ⅛ thickness depth from the surface, a pole density of {110}<111> orientation is 3.0 or less, and an arithmetic average roughness Ra of the surface after pickling is less than 1.2 μm.

### TECHNICAL FIELD

The present invention relates to a hot-rolled steel sheet.

Priority is claimed on Japanese Patent Application No. 2021-203094, filed Dec. 15, 2021, the content of which is incorporated herein by reference.

### BACKGROUND ART

In consideration of global environment protection, the weights of automobile bodies have been reduced in order to improve fuel efficiency of automobiles. In order to further reduce the weight of automobile bodies, it is necessary to increase the strength of steel sheets applied to automobile bodies. However, generally, if the strength of steel sheets increases, the formability deteriorates.

As a method of improving formability of steel sheets, there is a method of incorporating retained austenite into a microstructure of a steel sheet. However, when the microstructure of the steel sheet contains retained austenite, the ductility is improved, but bendability may deteriorate. When such as bend forming is performed, not only excellent ductility but also excellent bendability are required.

Patent Document 1 discloses a hot-rolled steel sheet having excellent local deformability and excellent ductility with little orientation dependence of formability and a method of producing the same.

### CITATION LIST

### Patent Document

[Patent Document 1]
Japanese Patent No. 5533729

### SUMMARY OF THE INVENTION

### Problems to be Solved by the Invention

The inventors have found that the hot-rolled steel sheet described in Patent Document 1 needs to have higher ductility and bendability.

The present invention has been made in view of the above circumstances. An object of the present invention is to provide a hot-rolled steel sheet having high strength, and excellent ductility and bendability.

### Means for Solving the Problem

In view of the above circumstances, the inventors conducted extensive studies regarding the relationship between a chemical composition and microstructure of a hot-rolled steel sheet, and mechanical properties. As a result, the following findings were obtained, and the present invention was completed.

In order to include retained austenite in a microstructure of a steel sheet, it is effective to increase the Si content. However, when the Si content is increased, scale may remain after descaling during hot rolling, which deteriorates bendability of the hot-rolled steel sheet. The present inventors have discovered that deterioration in bendability due to residual scale can be suppressed by controlling the texture and surface properties of the hot-rolled steel sheet.

The gist of the present invention achieved based on the above findings is as follows.

(1) A hot-rolled steel sheet according to one aspect of the present invention having a chemical composition comprising, in mass %,
C: 0.100 to 0.350%,
Si: 0.30 to 3.00%,
Mn: 1.00 to 4.00%,
sol. Al: 0.001 to 2.000%,
Si+sol. Al: 1.00 to 5.00%,
P: 0.100% or less,
S: 0.0300% or less,
N: 0.1000% or less,
O: 0.0100% or less,
Ti: 0 to 0.380%,
Nb: 0 to 0.100%,
V: 0 to 0.500%,
Cu: 0 to 2.00%,
Cr: 0 to 2.00%,
Mo: 0 to 1.00%,
Ni: 0 to 2.00%,
B: 0 to 0.0100%,
Ca: 0 to 0.0200%,
Mg: 0 to 0.0200%,
REM: 0 to 0.1000%,
Bi: 0 to 0.020%,
one, two or more of Zr, Co, Zn and W: 0 to 1.00% in total,
Sn: 0 to 0.050%, and
a remainder comprising Fe and impurities, and
wherein a microstructure comprises, in area %,
   bainite: 55 to 95%,
   retained austenite: 5 to 30%,
   fresh martensite: 5% or less,
   ferrite: 5% or less, and
   pearlite: 5% or less,
in a texture at a region from a surface to a ⅛ thickness depth from the surface, a pole density of {110}<111> orientation is 3.0 or less, and
an arithmetic average roughness Ra of the surface after pickling is less than 1.2 μm.
   (2) The hot-rolled steel sheet according to (1),
wherein the chemical composition comprises, in mass %, one, two or more selected from the group consisting of
Ti: 0.005 to 0.380%,
Nb: 0.005 to 0.100%,
V: 0.005 to 0.500%,
Cu: 0.01 to 2.00%,
Cr: 0.01 to 2.00%,
Mo: 0.01 to 1.00%,
Ni: 0.02 to 2.00%,
B: 0.0001 to 0.0100%,
Ca: 0.0005 to 0.0200%,
Mg: 0.0005 to 0.0200%,
REM: 0.0005 to 0.1000%, and
Bi: 0.0005 to 0.020%.

### Effects of the Invention

According to the above aspect of the present invention, it is possible to provide a hot-rolled steel sheet having high strength, and excellent ductility and bendability.

### EMBODIMENTS OF THE INVENTION

A chemical composition and a microstructure of a hot-rolled steel sheet according to the present embodiment will be described in detail. However, the present invention is not limited to only the configuration disclosed in the present embodiment and can be variously modified without departing from the gist of the present invention.

Hereinafter, a numerical value limiting a range indicated by “to” includes both the lower limit value and the upper limit value. Numerical values indicated by “less than” or “more than” are not included in these numerical value range. In the following description, % related to the chemical composition of the steel sheet is mass % unless otherwise specified.

### Chemical Composition

A chemical composition of a hot-rolled steel sheet according to the present embodiment contains, in mass %, C: 0.100 to 0.350%, Si: 0.30 to 3.00%, Mn: 1.00 to 4.00%, sol. Al: 0.001 to 2.000%, Si+sol. Al: 1.00 to 5.00%, P: 0.100% or less, S: 0.0300% or less, N: 0.1000% or less, O: 0.0100% or less, and the remainder: Fe and impurities.

Hereinafter, respective elements will be described in detail.

### C: 0.100 to 0.350%

C is an element required to obtain desired strength. If the C content is less than 0.100%, it is difficult to obtain desired strength. Therefore, the C content is 0.100% or more. The C content is preferably 0.120% or more or 0.150% or more.

On the other hand, if the C content is more than 0.350%, the transformation rate becomes slow, an MA (a mixed phase of martensite and retained austenite) is likely to be generated, and it is difficult to obtain excellent ductility. Therefore, the C content is 0.350% or less. The C content is preferably 0.330% or less, 0.310% or less, 0.300% or less or 0.280% or less.

### Si: 0.30 to 3.00%

Si has a function of delaying precipitation of cementite. This function can increase the amount of untransformed austenite remaining, that is, the area ratio of retained austenite. In addition, the strength of the hot-rolled steel sheet can be increased by maintaining a large amount of C dissolved in a hard phase and preventing cementite from coarsening. In addition, Si itself also has an effect of increasing the strength of the hot-rolled steel sheet according to solid solution strengthening. In addition, Si has a function of minimizing flaws in steel (minimizing the occurrence of defects such as blowholes in steel) by deoxidation. If the Si content is less than 0.30%, it is not possible to obtain the effect of the above function. Therefore, the Si content is 0.30% or more. The Si content is preferably 0.50% or more, 1.00% or more, 1.20% or more, or 1.50% or more.

On the other hand, if the Si content is more than 3.00%, this is not preferable because precipitation of cementite is significantly delayed and the amount of retained austenite becomes excessive. In addition, the surface properties and chemical convertibility of the hot-rolled steel sheet, as well as, ductility and weldability, significantly deteriorate, and the A₃ transformation point significantly rises. Accordingly, it is difficult to stably perform hot rolling. Therefore, the Si content is 3.00% or less. The Si content is preferably 2.70% or less or 2.50% or less.

### Mn: 1.00 to 4.00%

Mn has a function of inhibiting ferrite transformation and increasing the strength of the hot-rolled steel sheet. If the Mn content is less than 1.00%, it is not possible to obtain desired strength of the hot-rolled steel sheet. Therefore, the Mn content is 1.00% or more. The Mn content is preferably 1.30% or more, 1.50% or more, 1.80% or more, 2.00% or more or 2.40% or more.

On the other hand, if the Mn content is more than 4.00%, the ductility of the hot-rolled steel sheet deteriorates. Therefore, the Mn content is 4.00% or less. The Mn content is preferably 3.70% or less, 3.50% or less, 3.30% or less or 3.00% or less.

sol. Al: 0.001 to 2.000%

Like Si, sol. Al has a function of deoxidizing steel and minimizing flaws in the steel sheet, inhibiting precipitation of cementite from austenite, and promoting generation of retained austenite. If the sol. Al content is less than 0.001%, it is not possible to obtain the effect of the above function. Therefore, the sol. Al content is 0.001% or more. The sol. Al content is preferably 0.010% or more.

On the other hand, if the sol. Al content is more than 2.000%, the above effect is maximized and it is not economically preferable. In addition, the A₃ transformation point significantly rises, and it is difficult to stably perform hot rolling. Therefore, the sol. Al content is 2.000% or less. The sol. Al content is preferably 1.500% or less or 1.300% or less.

Here, in the present embodiment, sol. Al is acid-soluble Al, and indicates solid solution Al present in steel in a solid solution state.

Si+sol. Al: 1.00 to 5.00%

Si and sol. Al both have a function of delaying precipitation of cementite, and this function can increase the amount of untransformed austenite remaining, that is, the area ratio of retained austenite. If a total amounts of Si and sol. Al is less than 1.00%, it is not possible to obtain the effect of the above function. Therefore, the total amounts of Si and sol. Al is 1.00% or more, and preferably 1.20% or more or 1.50% or more.

The total amounts of Si and sol. Al may be 5.00% or less, 3.00% or less or 2.60% or less.

Here, Si of “Si+sol. Al” indicates the content (mass %) of Si, and sol. Al indicates the content (mass %) of sol. Al.

### P: 0.100% or Less

P is an element that is generally contained in steel as impurities, and has a function of increasing the strength of the hot-rolled steel sheet according to solid solution strengthening. Therefore, P may be actively contained. However, P is an element that easily segregates, and if the P content is more than 0.100%, the ductility of the hot-rolled steel sheet is significantly lowered due to grain boundary segregation. Therefore, the P content is 0.100% or less. The P content is preferably 0.050% or less or 0.030% or less.

Although it is not particularly necessary to specify the lower limit of the P content, and the P content may be 0%. The P content is preferably set to 0.001% or more from the viewpoint of refining cost.

### S: 0.0300% or Less

S is an element that is generally contained in steel as impurities, and forms sulfide-based inclusions in steel and lowers the ductility of the hot-rolled steel sheet. If the S content is more than 0.0300%, the ductility of the hot-rolled steel sheet is significantly lowered. Therefore, the S content is 0.0300% or less. The S content is preferably 0.0100% or less or 0.0050% or less.

Although it is not particularly necessary to specify the lower limit of the S content, and the S content may be 0%. The S content is preferably set to 0.0001% or more from the viewpoint of refining cost.

### N: 0.1000% or Less

N is an element that is generally contained in steel as impurities, and has a function of lowering the ductility of the hot-rolled steel sheet. If the N content is more than 0.1000%, the ductility of the hot-rolled steel sheet is significantly lowered. Therefore, the N content is 0.1000% or less. The N content is preferably 0.0800% or less, or 0.0700% or less. Although it is not particularly necessary to specify the lower limit of the N content, and the N content may be 0%. In order to promote precipitation of carbonitride, the N content is preferably 0.0010% or more and more preferably 0.0020% or more.

### O: 0.0100% or Less

When a large amount of O is contained in steel, a coarse oxide that acts as a starting point for fracture is formed, which causes brittle fracture or hydrogen-induced cracking. Therefore, the O content is 0.0100% or less. The O content is preferably 0.0080% or less or 0.0050% or less.

In order to disperse a large number of fine oxides during deoxidizing of molten steel, the O content may be 0.0005% or more or 0.0010% or more.

The remainder of the chemical composition of the hot-rolled steel sheet according to the present embodiment may consist of Fe and impurities. In the present embodiment, impurities are elements that are mixed in from ores or scrap as raw materials or a production environment or the like, or elements that are intentionally added in very small amounts, and have a meaning that they are allowable as long as they do not adversely affect the hot-rolled steel sheet according to the present embodiment.

The hot-rolled steel sheet according to the present embodiment may contain the following elements as optional elements in addition to the following elements. The lower limit of the content when the above optional elements are not contained is 0%. Hereinafter, respective optional elements will be described in detail.
Ti: 0.005 to 0.380%
Nb: 0.005 to 0.100%
V: 0.005 to 0.500%

Ti, Nb and V all precipitate as carbides or nitrides in steel, and have a function of refining the microstructure according to a pinning effect, and thus one, two or more of these elements may be contained. In order to more reliably obtain the effect of the above function, it is preferable to set the Ti content to 0.005% or more, the Nb content to 0.005% or more, or the V content to 0.005% or more.

However, even if these elements are excessively contained, the effect of the above function is maximized and it is not economically preferable. Therefore, the Ti content is set to 0.380% or less, the Nb content is set to 0.100% or less, and the V content is set to 0.500% or less.
Cu: 0.01 to 2.00%
Cr: 0.01 to 2.00%
Mo: 0.01 to 1.00%
Ni: 0.02 to 2.00%
B: 0.0001 to 0.0100%

Cu, Cr, Mo, Ni and B all have a function of increasing the hardenability of the hot-rolled steel sheet. In addition, Cr and Ni have a function of stabilizing retained austenite, and Cu and Mo have a function of precipitating carbides in steel and increasing the strength of the hot-rolled steel sheet. In addition, when Cu is contained, Ni has a function of effectively reducing grain boundary cracks of a slab caused by Cu. Therefore, one, two or more of these elements may be contained.

As described above, Cu has a function of increasing the hardenability of the steel sheet and a function of precipitating carbides in steel at a low temperature and increasing the strength of the hot-rolled steel sheet. In order to more reliably obtain the effect of the above function, the Cu content is preferably 0.01% or more.

However, if the Cu content is more than 2.00%, grain boundary cracks may occur in the slab. Therefore, the Cu content is 2.00% or less.

As described above, Cr has a function of increasing the hardenability of the steel sheet and a function of stabilizing retained austenite. In order to more reliably obtain the effect of the above function, the Cr content is preferably 0.01% or more.

However, if the Cr content is more than 2.00%, the chemical convertibility of the hot-rolled steel sheet is significantly lowered. Therefore, the Cr content is 2.00% or less.

As described above, Mo has a function of increasing the hardenability of the steel sheet and a function of precipitating carbides in steel and increasing the strength. In order to more reliably obtain the effect of the above function, the Mo content is preferably 0.01% or more.

However, even if the Mo content is more than 1.00%, the effect of the above function is maximized, and it is not economically preferable. Therefore, the Mo content is 1.00% or less.

As described above, Ni has a function of increasing the hardenability of the steel sheet. In addition, when Cu is contained, Ni has a function of effectively reducing grain boundary cracks of a slab caused by Cu. In order to more reliably obtain the effect of the above function, the Ni content is preferably 0.02% or more.

Since Ni is an expensive element, containing a large amount thereof is not economically preferable. Therefore, the Ni content is 2.00% or less.

As described above, B has a function of increasing the hardenability of the steel sheet. In order to more reliably obtain the effect of the function, the B content is preferably 0.0001% or more.

However, if the B content is more than 0.0100%, since the ductility of the hot-rolled steel sheet is significantly lowered, the B content is 0.0100% or less.

Ca: 0.0005 to 0.0200% Mg: 0.0005 to 0.0200% REM: 0.0005 to 0.1000% Bi: 0.0005 to 0.020%

Ca, Mg and REM all have a function of controlling the shape of the inclusion to a preferable shape and increasing the formability of the hot-rolled steel sheet. In addition, Bi has a function of refining the solidified structure and increasing the formability of the hot-rolled steel sheet. Therefore, one, two or more of these elements may be contained. In order to more reliably obtain the effect of the above function, it is preferable to contain 0.0005% or more of any one or more of Ca, Mg, REM and Bi. However, if the Ca content or the Mg content is more than 0.0200% or the REM content is more than 0.1000%, inclusions are excessively generated in steel and thus the ductility of the hot-rolled steel sheet may be lowered. In addition, even if the Bi content is more than 0.020%, the effect of the above function is maximized, and it is not economically preferable. Therefore, the Ca content and the Mg content are 0.0200% or less, the REM content is 0.1000% or less, and the Bi content is 0.020% or less. The Bi content is preferably 0.010% or less.

Here, REM refers to a total of 17 elements constituting of Sc, Y and lanthanides, and the REM content refers to a total amounts of these elements. In the case of lanthanides, they are industrially added in the form of misch metals.

One, two or more of Zr, Co, Zn and W: 0 to 1.00% in total

### Sn: 0 to 0.050%

Regarding Zr, Co, Zn and W, the inventors confirmed that, even if a total amount of 1.00% or less of these elements is contained, the effects of the hot-rolled steel sheet according to the present embodiment are not impaired. Therefore, a total amount of 1.00% or less of one, two or more of Zr, Co, Zn and W may be contained.

In addition, the inventors confirmed that, even if a small amount of Sn is contained, the effects of the hot-rolled steel sheet according to the present embodiment are not impaired, but flaws during hot rolling may occur so that the Sn content is 0.050% or less.

The chemical composition of the above hot-rolled steel sheet may be measured by a general analysis method. For example, inductively coupled plasma-atomic emission spectrometry (ICP-AES) may be used for measurement. Here, sol. Al may be measured through ICP-AES using a filtrate after thermal decomposition of a sample with an acid. C and S may be measured using a combustion-infrared absorption method, N may be measured using an inert gas fusion-thermal conductivity method, and O may be measured using an inert gas fusion-non-dispersive infrared absorption method.

### Microstructure of Hot-Rolled Steel Sheet

Next, a microstructure of a hot-rolled steel sheet according to the present embodiment will be described.

In the hot-rolled steel sheet according to the present embodiment, the microstructure comprises, in area %, bainite: 55 to 95%, retained austenite: 5 to 30%, fresh martensite: 5% or less, ferrite: 5% or less, and pearlite: 5% or less, in a texture at a region from a surface to a ⅛ thickness depth from the surface, a pole density of {110}<111> orientation is 3.0 or less.

Here, in the present embodiment, the microstructure is specified in the sheet thickness cross section parallel to the rolling direction, at a depth position of ¼ of the sheet thickness from the surface (a region from a depth of ⅛ of the sheet thickness from the surface to a depth of ⅜ of the sheet thickness from the surface). The reason for this is that the microstructure at that position is a typical microstructure of the hot-rolled steel sheet.

### Bainite: 55 to 95%

Bainite is a structure that improves the strength and ductility of the hot-rolled steel sheet. If the area ratio of bainite is less than 55%, it is not possible to obtain desired strength and ductility of the hot-rolled steel sheet. Therefore, the area ratio of bainite is 55% or more. The area ratio of bainite is preferably 60% or more, 65% or more or 70% or more.

On the other hand, if the area ratio of bainite is more than 95%, it is not possible to obtain desired ductility. Therefore, the area ratio of bainite is 95% or less. The area ratio of bainite is preferably 92% or less, less than 90%, 90% or less or 86% or less.

### Retained Austenite: 5 to 30%

Retained austenite is a structure that improves the ductility of the hot-rolled steel sheet. If the area ratio of retained austenite is less than 5%, it is not possible to obtain desired ductility of the hot-rolled steel sheet. Therefore, the area ratio of retained austenite is 5% or more. The area ratio of retained austenite is preferably 7% or more, more than 8%, 9% or more, 10% or more, 11% or more, 12% or more, 13% or more, 14% or more or 15% or more.

On the other hand, if the area ratio of retained austenite is more than 30%, it is not possible to obtain desired strength. Therefore, the area ratio of retained austenite is 30% or less, and preferably 25% or less or 23% or less.

### Fresh Martensite: 5% or Less

Since fresh martensite is a hard structure, it contributes to improving the strength of the hot-rolled steel sheet. However, fresh martensite is also a poorly ductile structure. If the area ratio of fresh martensite is more than 5%, it is not possible to obtain desired ductility of the hot-rolled steel sheet. Therefore, the area ratio of fresh martensite is 5% or less. The area ratio of fresh martensite is preferably 4% or less, 3% or less, or 2% or less. The area ratio of fresh martensite may be 0%.

### Ferrite: 5% or Less

Ferrite is a structure that improves the ductility of the hot-rolled steel sheet, although it has poor strength. If the area ratio of ferrite is more than 5%, it is not possible to obtain desired strength of the hot-rolled steel sheet. Therefore, the area ratio of ferrite is 5% or less. The area ratio of ferrite is preferably 4% or less, 3% or less or 2% or less. The area ratio of ferrite may be 0%.

### Pearlite: 5% or Less

If the area ratio of pearlite is too large, it is not possible to obtain a desired amount of retained austenite. Therefore, the area ratio of pearlite is 5% or less. The area ratio of pearlite is preferably 4% or less, 3% or less or 2% or less. The area ratio of pearlite may be 0%.

Among the above structures, the area ratio of structures other than retained austenite is measured by the following method.

A test piece is taken from the hot-rolled steel sheet so that the microstructure of the sheet thickness cross section parallel to the rolling direction at a depth of ¼ of the sheet thickness from the surface (a region from a depth of ⅛ of the sheet thickness from the surface to a depth of ⅜ of the sheet thickness from the surface) can be observed. Next, the sheet thickness cross section is polished, the polished surface is then subjected to nital corrosion, and a 30 μm×30 μm area is subjected to structure observation using an optical microscope and a scanning electron microscope (SEM). Observation areas are picked at least three areas. Image analysis is performed on the structure image obtained by the structure observation, and the area ratio of each of ferrite, pearlite and bainite is obtained. Then, Le Pera corrosion is performed on the same observation position, structure observation is then performed using an optical microscope and a scanning electron microscope, image analysis is performed on the obtained structure image, and thereby the area ratio of fresh martensite is obtained.

In the above structure observation, each structure is identified by the following method.

Fresh martensite is a structure having a high dislocation density and substructures such as blocks and packets within the grains so that it is possible to distinguish it from other microstructures according to electron channeling contrast images using a scanning electron microscope.

Regarded as bainite is a structure that is an aggregate of lath-shaped crystal grains and is not fresh martensite among structures that do not contain Fe-based carbides with a major axis of 20 nm or more inside the structure, or a structure which contains Fe-based carbides with a major axis of 20 nm or more inside the structure and in which the Fe-based carbides have a single variant, that is, Fe-based carbides extending in the same direction. Here, Fe-based carbides elongated in the same direction are Fe-based carbides with a difference of 5° or less in the elongation direction.

A structure that is a lump of crystal grains and does not contain substructures such as laths inside the structure is regarded as ferrite.

A structure in which plate-like ferrite and Fe-based carbides overlap in layers is regarded as pearlite.

The area ratio of retained austenite is measured by the following method.

In the present embodiment, the area ratio of retained austenite is measured by X-ray diffraction. First, in the sheet thickness cross section parallel to the rolling direction of the hot-rolled steel sheet, at a depth of ¼ of the sheet thickness from the surface (a region from a depth of ⅛ of the sheet thickness from the surface to a depth of ⅜ of the sheet thickness from the surface), using Co-Kα rays, an integrated intensity of a total of 6 peaks of α(110), α(200), α(211), γ(111), γ(200), and γ(220) is obtained, and the volume ratio of retained austenite is calculated using the intensity averaging method. This volume ratio of retained austenite is regarded as the area ratio of retained austenite.

Pole Density of {110}<111> Orientation in a Texture at a Region from a Surface to a ⅛ Thickness Depth from the Surface: 3.0 or Less

If the pole density of {110}<111> orientation in a texture at a region (hereinafter, sometimes referred to as a surface layer region) from a surface to a ⅛ thickness depth from the surface is more than 3.0, the bendability of the hot-rolled steel sheet deteriorates. Therefore, the pole density of {110}<111> orientation at the surface layer region is set to 3.0 or less. The pole density of {110}<111> orientation at the surface layer region is preferably 2.8 or less, 2.5 or less or 2.3 or less. The lower limit is not particularly specified, but the pole density of {110}<111> orientation at the surface layer region may be set as 0.7 or more or 1.0 or more.

For the pole densities, an EBSD device in which a scanning electron microscope and an EBSD analyzer are combined and OIM analysis (registered trademark) manufactured by AMETEK Inc. are used. From an orientation distribution function (ODF), that is calculated by using orientation data measured by an electron backscattering diffraction (EBSD) method and a spherical harmonic function, and that displays a three-dimensional texture, the pole density of the {110}<111> orientation at φ2=45° section in the texture of the surface layer region is obtained.

A measurement range is set to the region from the surface to the ⅛ thickness depth from the surface. Measurement pitches are set to 5 μm/step.

It should be noted that {hkl} indicates a crystal plane parallel to a rolled surface and <uvw> indicates a crystal direction parallel to the rolling direction. That is, {hkl}<uvw> indicates a crystal in which {hkl} is oriented in a sheet surface normal direction and <uvw> is oriented in the rolling direction.

The rolling direction of the hot-rolled steel sheet can be determined by the following method.

First, a test piece is collected so that sheet thickness cross sections of the hot-rolled steel sheet can be observed. The sheet thickness cross section of the collected test piece is finished by mirror polishing and then observed using an optical microscope. An observation range is set to an overall thickness of the sheet thickness, a direction parallel to a direction in which the crystal grains extend is determined to be the rolling direction.

An Arithmetic Average Roughness Ra of the Surface after Pickling: Less than 1.2 μm

In the hot-rolled steel sheet according to the present embodiment, the arithmetic average roughness Ra of the surface after pickling is less than 1.2 μm. If the arithmetic average roughness Ra of the surface after pickling is 1.2 μm or more, the bendability of the hot-rolled steel sheet deteriorates. Therefore, the arithmetic average roughness Ra of the surface after pickling is set to less than 1.2 μm. The arithmetic average roughness Ra of the surface after pickling is preferably 1.1 μm or less, 1.0 μm or less, 0.9 μm or less, 0.8 μm or less, or 0.7 μm or less.

The lower limit of the arithmetic average roughness Ra of the surface after pickling is not particularly specified, but the arithmetic average roughness Ra of the surface after pickling may set to 0.3 μm or more.

The arithmetic average roughness Ra of the surface after pickling is measured by following method.

First, the hot-rolled steel sheet is pickled by the following method. The pickling treatment may be performed in a conventional procedure, for example, by immersion in hydrochloric acid having a hydrochloric acid concentration of 3 to 10% by volume at a temperature of 85 to 98° C. for 20 to 300 seconds. Further, the pickling may be performed once, or may be performed in multiple times if necessary. The above pickling time (20 to 300 seconds) means the pickling time when pickling is performed only once, and the total time of picklings when pickling is performed multiple times. It is preferable to set the pickling temperature to 85° C. or higher because oxides of the surface layer can be sufficiently removed. Although the upper limit of the pickling temperature is not particularly specified, it is realistically about 98° C. If the pickling time exceeds 300 seconds, the surface roughness will become excessively rough and the surface quality will deteriorate. Furthermore, the unevenness remaining after cold rolling will cause a notch-like effect, which deteriorates the bendability of the hot-rolled steel sheet. The upper limit of the pickling time is preferably 200 seconds.

Next, a sample of 1000 mm×1000 mm is taken from the hot-rolled steel sheet after the pickling. On the surface of the sample, measurement points are set at 200 mm intervals in the rolling direction and the sheet width direction, and the surface roughness is measured at each measurement point. However, the measurement length at each measurement point is set to 5 mm. A roughness curve is obtained by sequentially applying contour curve filters with cutoff values λc and λs to the measured cross-sectional curve obtained by the measurement. Specifically, from the obtained measurement results, components with a wavelength λc of 0.8 mm or less and components with a wavelength λs of 2.5 μm or more are removed to obtain the roughness curve. Based on the obtained roughness curve, the arithmetic average roughness Ra of each measurement point is calculated in accordance with JIS B 0601:2013. By calculating the average value of the measured values obtained at each measurement point, the arithmetic average roughness Ra of the surface is obtained.

When the hot-rolled steel sheet has a surface treatment film such as plating or coating on its surface, the arithmetic average roughness Ra is measured after performing the above pickling on the surface of the base steel obtained after removing the surface treatment film from the hot-rolled steel sheet. The method for removing the surface treatment film can be appropriately selected depending on the type of the surface treatment film within a range that does not affect the surface roughness of the base steel. For example, when the surface treatment film is a galvanized layer, the galvanized layer may be dissolved using dilute hydrochloric acid containing an inhibitor. Thereby, only the galvanized layer can be peeled off from the steel sheet. An inhibitor is an additive used to suppress changes in roughness due to prevention of excessive dissolution of the base steel. For example, it is possible to use hydrochloric acid diluted 10 to 100 times with the addition of “IBIT No. 700BK”, a corrosion inhibitor for hydrochloric acid pickling manufactured by Asahi Chemical Co., Ltd., to a concentration of 0.6 g/L can be used.

### Mechanical Properties

The hot-rolled steel sheet according to the present embodiment may have a tensile (maximum) strength of 980 MPa or more. If the tensile strength is set to 980 MPa or more, it is possible to contribute to weight reduction of the vehicle body. More preferably, the tensile strength is 1,180 MPa or more. It is not particularly necessary to specify the upper limit, but may be 1,470 MPa.

The product (TSxuEl) of the tensile strength and uniform elongation, which is an index of ductility, may be 8,260 MPa·% or more.

The critical bend R/t, which is an index of bendability, may be 1.80 or less.

The tensile strength TS and the uniform elongation uEl are measured by tensile test according to JIS Z 2241:2011 using No. 5 test piece of JIS Z 2241:2011. The position of the tensile test piece that is taken out may be a part of ¼ from the end in the sheet width direction, and the direction perpendicular to the rolling direction may be a longitudinal direction.

The critical bend R/t is evaluated by the following bending test.

A strip-shaped test piece of 100 mm×30 mm is cut out from a ¼ position in the sheet width direction of the hot-rolled steel sheet. Regarding both bending (L-axis bending) in which the bend ridge is parallel to the rolling direction (L direction) and bending (C-axis bending) in which the bend ridge is perpendicular to the rolling direction (C direction), a bending test is performed according to V block method (the bending angle is) 90° of JIS Z 2248:2006 to obtain a minimum bend radius without cracking. The critical bend R/t is obtained by calculating the average value of the minimum bend radius of the L-axis and the C-axis divided by the sheet thickness.

The rolling direction of the hot-rolled steel sheet may be determined by the method described above.

Here, the presence or absence of cracks is determined by observing the cracks with an optical microscope on a cross section after mirror-polishing, which is cut along parallel to the bending direction and perpendicular to the sheet surface from the test piece after the bending test, and then, if the length of the crack observed on the inside of the bend of the test piece exceeds 30 μm, it is determined that there is a crack.

### Sheet Thickness

The sheet thickness of the hot-rolled steel sheet according to the present embodiment is not particularly limited, but may be 0.5 to 8.0 mm. When the sheet thickness of the hot-rolled steel sheet is set to 0.5 mm or more, it is possible to easily secure the rolling completion temperature, it is possible to reduce the rolling load, and it is possible to easily perform hot rolling. Therefore, the sheet thickness of the hot-rolled steel sheet according to the present embodiment may be 0.5 mm or more, and is preferably 1.2 mm or more or 1.4 mm or more. In addition, when the sheet thickness is set to 8.0 mm or less, the microstructure can be easily refined, and it is possible to easily secure the above microstructure. Therefore, the sheet thickness may be 8.0 mm or less, and is preferably 6.0 mm or less.

### Plating

The hot-rolled steel sheet according to the present embodiment having the chemical composition and microstructure described above may have a plating on the surface in order to improve corrosion resistance, and may be used as a surface-treated steel sheet. The plating may be an electroplating or a melt plating. Examples of electroplating include electrogalvanizing and electro Zn—Ni alloy plating. Examples of melt plating include melt galvanizing, alloyed melt galvanizing, melt aluminum plating, melt Zn—Al alloy plating, melt Zn—Al—Mg alloy plating, and melt Zn—Al—Mg—Si alloy plating. The amount of plating adhered is not particularly limited, and may be the same as in the related art. In addition, after plating, an appropriate chemical conversion treatment (for example, applying a silicate-based chromium-free chemical conversion treatment solution and drying) is performed, and it is possible to further improve corrosion resistance.

### Manufacturing Conditions

In a preferable manufacturing method of a hot-rolled steel sheet according to the present embodiment, the following processes (1) to (8) are performed in order. By adapting the following manufacturing method, the hot rolled steel sheet according to the present embodiment can be stably manufactured.

Here, the temperature of the slab and the temperature of the steel sheet in the present embodiment refer to the surface temperature of the slab and the surface temperature of the steel sheet. In the present embodiment, the temperature of the hot-rolled steel sheet is measured with a contact or non-contact thermometer if the location is the outermost end in the sheet width direction. If the location is somewhere other than the outermost end of the hot-rolled steel sheet in the sheet width direction, the temperature is measured by a thermocouple or calculated by heat transfer analysis.
(1) A slab having the above chemical composition is heated in a temperature range of 1,170° C. or higher, and held in the temperature range.
(2) Rough rolling is performed so that a final rolling reduction ratio is 30% or lower.
(3) A maximum temperature after completion of rough rolling and before finish rolling is set to T1 (° C.) or higher represented by the following Formula (A) or (B)

$$when sol . \text{Al/Si} = a ,$$

$$if a \leq 1 / 3 ,$$

$$T 1 = 315 \times {a}^{2} - 315 \times a + 1170 \qquad ( A )$$

$$If a > 1 / 3 ,$$

$$T 1 = 1 , 100 - 3.6 \times Si + 53 \times sol . Al - 6.7 \times a \qquad ( B )$$

Here, each element symbol indicates the content in mass % of the element.
(4) Descaling at collision pressure of 2.5 MPa or more is performed after completion of rough rolling and before finish rolling.
(5) Finish rolling is performed so that a finishing temperature is T2 (° C.) or more represented by the following Formula (C), and a cumulative rolling reduction ratio of rollings at a final stand and at a one stand before the final stand is lower than 30%.

$$T 2 = 830 + 600 \times Ti + 9 , 000 \times Nb \qquad ( C )$$

Here, each element symbol indicates the content in mass % of the element, and if the element is not contained, 0 is substituted.
(6) Cooling is performed to a temperature range of 350 to 450° C. at an average cooling rate of 30° C./s or faster.
(7) Coiling is performed in a temperature range of 350 to 450° C.
(8) The average cooling rate to a temperature range of 150° C. or lower is set to 15 to 40° C./h.

### (1) Slab Heating

For a slab to be hot-rolled, a slab obtained by continuous casting or a slab obtained by casting and blooming can be used. As necessary, one obtained by performing hot processing or cold processing on a slab can be used. It is preferable to heat the slab to be hot-rolled in the temperature range of 1,170° C. or higher. Furthermore, it is more preferable to hold the slab in the temperature range for 6,000 seconds or longer. By heating to the above temperature range, as a result, the desired arithmetic average roughness Ra of the surface after pickling can be obtained.

For hot-rolling, it is preferable to use a reverse mill or tandem mill for multi-pass rolling. In particular, in consideration of industrial productivity, it is more preferable to perform hot rolling using a tandem mill for at least the last several stands.

### (2) Rough Rolling

In rough rolling, the rolling reduction ratio of final stand (the final rolling reduction ratio) is preferably set to 30% or lower. By setting the final rolling reduction ratio to 30% or lower, as a result, the desired arithmetic average roughness Ra of the surface after pickling can be obtained.

The final rolling reduction ratio can be expressed as (t0−t1)/t0×100(%) when the inlet sheet thickness in final stand is t0, and the outlet sheet thickness after rolling of the final stand is t1.

(3) The Maximum Temperature after Completion of Rough Rolling and Before Finish Rolling

It is preferable to set the maximum temperature after completion of rough rolling and before finish rolling to T1 (C) or higher represented by the above Formula (A) or (B). By setting the maximum temperature to T1 (C) or higher, as a result, the desired arithmetic average roughness Ra of the surface after pickling can be obtained.

### (4) Descaling Before Finish Rolling

After completion of rough rolling and before finish rolling, it is preferable to perform descaling at collision pressure of 2.5 MPa or more. Descaling is a process in which scale formed on the surface of the steel sheet is removed by injecting water from nozzles onto the upper surface and under surface of the steel sheet. When descaling is performed by injecting water using a plurality of nozzles, it is preferable to control the maximum collision pressure among the plurality of nozzles to 2.5 MPa or more. By performing descaling at collision pressure of 2.5 MPa or more, as a result, the desired arithmetic average roughness Ra of the surface after pickling can be obtained.

In order to preferably control the texture at the surface layer region, descaling is preferably performed at collision pressure of less than 3.0 MPa.

### Finish Rolling

In finish rolling, it is preferable that the finishing temperature is T2 (° C.) or higher represented by the above Formula (C), and the cumulative rolling reduction ratio of rollings at the final stand and at one stand before the final stand is lower than 30%. By setting the finishing temperature to T2 (C) or higher, as a result, the desired texture at the surface layer region can be obtained. Furthermore, by setting the cumulative rolling reduction ratio of rollings at the final stand and at one stand before the final stand to lower than 30%, the desired texture at the surface layer region can be obtained.

Here, the finishing temperature refers to the outlet temperature of the final stand of finish rolling. In addition, the cumulative rolling reduction ratio of rollings at the final stand and at the one stand before the final stand can be expressed as (t0−t1)/t0×100(%) when the inlet sheet thickness in the stand one stand before the final stand is to, and the outlet sheet thickness after the final stand is t1.

(6) Cooling after Finish Rolling

After completion of finish rolling, it is preferable to perform cooling to the temperature range of 350 to 450° C. at the average cooling rate of 30° C./s or faster. By setting the average cooling rate to the temperature range to 30° C./s or faster, it is possible to suppress generation of ferrite and pearlite. Furthermore, by the above cooling performed to the temperature range of 350 to 450° C., coiling can be performed at the desired temperature range.

Here, the average cooling rate referred to in the present embodiment is a value obtained by dividing a difference in temperature between the start of cooling and the end of cooling by a time elapsed from the start of cooling to the end of cooling.

### (7) Coiling

The coiling temperature is preferably in the temperature range of 350 to 450° C. When coiling is performed in this temperature range, it is possible to suppress excessive generation of fresh martensite, and it is possible to obtain the desired amount of bainite. Furthermore, it is possible to obtain the desired amount of retained austenite.

(8) Cooling after Coiling

After coiling, the average cooling rate to the temperature range of 150° C. or lower is preferably 15 to 40° C./h. By performing cooling at the average cooling rate of 15° C./h or faster, carbon can be concentrated in retained austenite and the retained austenite can be stabilized. As a result, a desired amount of retained austenite can be obtained. The average cooling rate is more preferably 20° C./h or faster. In addition, by performing cooling at the average cooling rate of 40° C./h or slower, it is possible to suppress generation of fresh martensite, and it is possible to obtain the desired amount of bainite. The average cooling rate is more preferably slower than 30° C./h.

In addition, the average cooling rate after coiling may be controlled using a heat insulating cover, an edge mask, mist cooling or the like.

### EXAMPLES

Next, effects of one aspect of the present invention will be described in more detail with reference to examples, but conditions in the examples are one condition example used for confirming the feasibility and effects of the present invention, and the present invention is not limited to this one condition example. In the present invention, various conditions can be used without departing from the gist of the present invention and as long as the object of the present invention can be achieved.

Steels having chemical compositions shown in Table 1 and Table 2 were melted, and slabs with a thickness of 240 to 300 mm were produced by continuous casting. Using the obtained slabs, hot-rolled steel sheets were obtained under manufacturing conditions shown in Table 3 and Table 4.

Here, before hot rolling, the sample was heated to the slab heating temperature shown in Table 3 and Table 4, and held for 6,000 seconds or more. The collision pressure of descaling before finish rolling was set to about 2.8 MPa. In addition, cooling after coiling was performed to a temperature range of 150° C. or lower at the average cooling rate in Table 3 and Table 4.

For the obtained hot-rolled steel sheets, the area ratio of each structure, the pole density, the arithmetic average roughness Ra of the surface after pickling, the tensile strength TS, the uniform elongation uEl, and the critical bend R/t were measured according to the above methods. Here, the arithmetic average roughness Ra of the surface after pickling was obtained by measuring the hot-rolled steel sheet after pickling according to the method described above. In addition, the tensile strength TS, the uniform elongation uEl and the critical bend R/t were obtained by measuring the hot-rolled steel sheet after pickling according to the method described above.

### Evaluation Criteria

If the tensile strength TS was 980 MPa or more, it was determined as having high strength and acceptable. On the other hand, if the tensile strength TS was less than 980 MPa, it was determined as not having high strength and unacceptable.

If the product (TSxuEl) of the tensile strength TS and the uniform elongation uEl was 8,260 MPa·% or more, it was determined as having excellent ductility and acceptable. On the other hand, if the TSxuEl was less than 8,260 MPa·%, it was determined as not having excellent ductility and unacceptable.

If the critical bend R/t was 1.80 or less, it was determined as having excellent bendability and acceptable. On the other hand, if the critical bend R/t was higher than 1.80, it was determined as not having excellent bendability and unacceptable.

TABLE 1

| | Mass %, remainder of Fe and impurities | | | | | | | | | | | | | | | | | |
|---|---|---|---|---|---|---|---|---|---|---|---|---|---|---|---|---|---|---|
| | | | | | Si + | | | | | | | | | | | | | |
| Steel | | | | sol. | sol. | | | | | | | | | | | | | |
| No. | C | Si | Mn | Al | Al | P | S | N | O | Ti | Nb | V | Cu | Cr | Mo | Ni | B | Note |
| A | 0.116 | 1.24 | 2.70 | 0.490 | 1.73 | 0.009 | 0.0019 | 0.0028 | 0.0022 | | | | | | | | | Steel |
| | | | | | | | | | | | | | | | | | | of the |
| | | | | | | | | | | | | | | | | | | present |
| | | | | | | | | | | | | | | | | | | invention |
| B | 0.220 | 1.84 | 2.43 | 0.240 | 2.08 | 0.013 | 0.0011 | 0.0036 | 0.0017 | | | | | | | | | Steel |
| | | | | | | | | | | | | | | | | | | of the |
| | | | | | | | | | | | | | | | | | | present |
| | | | | | | | | | | | | | | | | | | invention |
| C | 0.345 | 2.07 | 1.87 | 0.022 | 2.09 | 0.009 | 0.0020 | 0.0029 | 0.0028 | | | | | | | | | Steel |
| | | | | | | | | | | | | | | | | | | of the |
| | | | | | | | | | | | | | | | | | | present |
| | | | | | | | | | | | | | | | | | | invention |
| D | 0.224 | 0.40 | 2.07 | 1.980 | 2.38 | 0.015 | 0.0027 | 0.0035 | 0.0028 | | | | | | | | | Steel |
| | | | | | | | | | | | | | | | | | | of the |
| | | | | | | | | | | | | | | | | | | present |
| | | | | | | | | | | | | | | | | | | invention |
| E | 0.195 | 2.81 | 3.21 | 0.030 | 2.84 | 0.011 | 0.0011 | 0.0038 | 0.0034 | | | | | | | | | Steel |
| | | | | | | | | | | | | | | | | | | of the |
| | | | | | | | | | | | | | | | | | | present |
| | | | | | | | | | | | | | | | | | | invention |
| F | 0.210 | 1.42 | 1.38 | 0.300 | 1.72 | 0.010 | 0.0017 | 0.0026 | 0.0035 | | | | | | | | | Steel |
| | | | | | | | | | | | | | | | | | | of the |
| | | | | | | | | | | | | | | | | | | present |
| | | | | | | | | | | | | | | | | | | invention |
| G | 0.140 | 1.65 | 3.87 | 0.023 | 1.67 | 0.011 | 0.0033 | 0.0024 | 0.0015 | | | | | | | | | Steel |
| | | | | | | | | | | | | | | | | | | of the |
| | | | | | | | | | | | | | | | | | | present |
| | | | | | | | | | | | | | | | | | | invention |
| H | 0.290 | 0.48 | 2.51 | 1.620 | 2.10 | 0.016 | 0.0021 | 0.0033 | 0.0030 | | | | | | | | | Steel |
| | | | | | | | | | | | | | | | | | | of the |
| | | | | | | | | | | | | | | | | | | present |
| | | | | | | | | | | | | | | | | | | invention |
| I | 0.210 | 1.84 | 1.94 | 0.032 | 1.87 | 0.009 | 0.0012 | 0.0019 | 0.0034 | 0.148 | | | | | | | | Steel |
| | | | | | | | | | | | | | | | | | | of the |
| | | | | | | | | | | | | | | | | | | present |
| | | | | | | | | | | | | | | | | | | invention |
| J | 0.185 | 1.86 | 2.08 | 0.520 | 2.38 | 0.018 | 0.0025 | 0.0020 | 0.0029 | | 0.025 | | | | | | | Steel |
| | | | | | | | | | | | | | | | | | | of the |
| | | | | | | | | | | | | | | | | | | present |
| | | | | | | | | | | | | | | | | | | invention |
| K | 0.168 | 1.24 | 2.21 | 0.300 | 1.54 | 0.014 | 0.0011 | 0.0024 | 0.0015 | 0.250 | 0.014 | | | | | | | Steel |
| | | | | | | | | | | | | | | | | | | of the |
| | | | | | | | | | | | | | | | | | | present |
| | | | | | | | | | | | | | | | | | | invention |
| L | 0.324 | 1.98 | 2.08 | 0.019 | 2.00 | 0.017 | 0.0027 | 0.0024 | 0.0029 | | | 0.042 | | | | | | Steel |
| | | | | | | | | | | | | | | | | | | of the |
| | | | | | | | | | | | | | | | | | | present |
| | | | | | | | | | | | | | | | | | | invention |
| M | 0.299 | 2.43 | 3.12 | 0.018 | 2.45 | 0.016 | 0.0030 | 0.0039 | 0.0016 | | | | 0.03 | | | | | Steel |
| | | | | | | | | | | | | | | | | | | of the |
| | | | | | | | | | | | | | | | | | | present |
| | | | | | | | | | | | | | | | | | | invention |
| N | 0.193 | 1.32 | 2.04 | 0.330 | 1.65 | 0.009 | 0.0025 | 0.0029 | 0.0028 | | | | | 0.39 | | | | Steel |
| | | | | | | | | | | | | | | | | | | of the |
| | | | | | | | | | | | | | | | | | | present |
| | | | | | | | | | | | | | | | | | | invention |
| O | 0.275 | 0.31 | 2.91 | 1.850 | 2.16 | 0.010 | 0.0031 | 0.0019 | 0.0034 | | | | | | 0.230 | | | Steel |
| | | | | | | | | | | | | | | | | | | of the |
| | | | | | | | | | | | | | | | | | | present |
| | | | | | | | | | | | | | | | | | | invention |
| P | 0.119 | 2.23 | 3.46 | 0.280 | 2.51 | 0.017 | 0.0035 | 0.0040 | 0.0035 | | | | | | | 0.26 | | Steel |
| | | | | | | | | | | | | | | | | | | of the |
| | | | | | | | | | | | | | | | | | | present |
| | | | | | | | | | | | | | | | | | | invention |
| Q | 0.123 | 2.05 | 3.87 | 0.023 | 2.07 | 0.018 | 0.0024 | 0.0033 | 0.0020 | | | | | | | | 0.0027 | Steel |
| | | | | | | | | | | | | | | | | | | of the |
| | | | | | | | | | | | | | | | | | | present |
| | | | | | | | | | | | | | | | | | | invention |
| R | 0.097 | 0.98 | 3.68 | 0.062 | 1.04 | 0.012 | 0.0029 | 0.0035 | 0.0021 | | | | | | | | | Compar- |
| | | | | | | | | | | | | | | | | | | ative |
| | | | | | | | | | | | | | | | | | | steel |
| S | 0.361 | 1.00 | 2.90 | 0.035 | 1.04 | 0.015 | 0.0018 | 0.0035 | 0.0017 | | | | | | | | | Compar- |
| | | | | | | | | | | | | | | | | | | ative |
| | | | | | | | | | | | | | | | | | | steel |
| T | 0.245 | 0.87 | 2.63 | 0.017 | 0.89 | 0.015 | 0.0036 | 0.0027 | 0.0020 | | | | | | | | | Compar- |
| | | | | | | | | | | | | | | | | | | ative |
| | | | | | | | | | | | | | | | | | | steel |
| U | 0.198 | 1.26 | 0.86 | 0.320 | 1.58 | 0.013 | 0.0011 | 0.0035 | 0.0020 | | | | | | | | | Compar- |
| | | | | | | | | | | | | | | | | | | ative |
| | | | | | | | | | | | | | | | | | | steel |
| V | 0.172 | 0.92 | 4.24 | 0.560 | 1.48 | 0.013 | 0.0029 | 0.0035 | 0.0028 | | | | | | | | | Compar- |
| | | | | | | | | | | | | | | | | | | ative |
| | | | | | | | | | | | | | | | | | | steel |

The underline indicates that it is outside the scope of the present invention

TABLE 2

| Steel | Mass %, remainder of Fe and impurities | | | | | | | | | | | | T1 | T2 | |
|---|---|---|---|---|---|---|---|---|---|---|---|---|---|---|---|
| No. | Ca | Mg | REM | Bi | Zr | Co | Zn | W | Sn | Sol. Al/Si | Formula (A) | Formula (B) | (° C.) | (° C.) | Note |

| | | | | | | | | | | | | | | |
|---|---|---|---|---|---|---|---|---|---|---|---|---|---|---|
| A | 0.0025 | 0.0013 | | | | | | | 0.395 | 1095 | 1119 | 1119 | 830 | Steel of the |
| | | | | | | | | | | | | | | present invention |
| B | | | | | | | | | 0.130 | 1134 | 1105 | 1134 | 830 | Steel of the |
| | | | | | | | | | | | | | | present invention |
| C | | | 0.0015 | | | | | | 0.011 | 1167 | 1094 | 1167 | 830 | Steel of the |
| | | | | | | | | | | | | | | present invention |
| D | | | | 0.003 | | | | | 4.950 | 7329 | 1170 | 1170 | 830 | Steel of the |
| | | | | | | | | | | | | | | present invention |
| E | | | | | | | | | 0.011 | 1167 | 1091 | 1167 | 830 | Steel of the |
| | | | | | | | | | | | | | | present invention |
| F | | | | | | | | | 0.211 | 1118 | 1109 | 1118 | 830 | Steel of the |
| | | | | | | | | | | | | | | present invention |
| G | | | | | | | | | 0.014 | 1166 | 1095 | 1166 | 830 | Steel of the |
| | | | | | | | | | | | | | | present invention |
| H | | | | | | | | | 3.375 | 3695 | 1162 | 1162 | 830 | Steel of the |
| | | | | | | | | | | | | | | present invention |
| I | | | | | 0.06 | | | | 0.017 | 1165 | 1095 | 1165 | 919 | Steel of the |
| | | | | | | | | | | | | | | present invention |
| J | | | | | | | | | 0.280 | 1107 | 1119 | 1107 | 1055 | Steel of the |
| | | | | | | | | | | | | | | present invention |
| K | | | | | | | | | 0.242 | 1112 | 1110 | 1112 | 1106 | Steel of the |
| | | | | | | | | | | | | | | present invention |
| L | | | | | | | 0.03 | | 0.010 | 1167 | 1094 | 1167 | 830 | Steel of the |
| | | | | | | | | | | | | | | present invention |
| M | | | | | | 0.02 | | | 0.007 | 1168 | 1092 | 1168 | 830 | Steel of the |
| | | | | | | | | | | | | | | present invention |
| N | | | | | | | | | 0.250 | 1111 | 1111 | 1111 | 830 | Steel of the |
| | | | | | | | | | | | | | | present invention |
| O | | | | | | | | 0.024 | 5.968 | 10509 | 1157 | 1157 | 830 | Steel of the |
| | | | | | | | | | | | | | | present invention |
| P | | | | | | | | | 0.126 | 1135 | 1106 | 1135 | 830 | Steel of the |
| | | | | | | | | | | | | | | present invention |
| Q | | | | | | | | | 0.011 | 1167 | 1094 | 1167 | 830 | Steel of the |
| | | | | | | | | | | | | | | present invention |
| R | | | | | | | | | 0.063 | 1151 | 1099 | 1151 | 830 | Comparative steel |
| S | | | | | | | | | 0.035 | 1159 | 1098 | 1159 | 830 | Comparative steel |
| T | | | | | | | | | 0.020 | 1164 | 1098 | 1164 | 830 | Comparative steel |
| U | | | | | | | | | 0.254 | 1110 | 1111 | 1110 | 830 | Comparative steel |
| V | | | | | | | | | 0.609 | 1095 | 1122 | 1122 | 830 | Comparative steel |

TABLE 3

| | | | | | | | | Cumulative | | | | |
|---|---|---|---|---|---|---|---|---|---|---|---|---|
| | | | | | | | | rolling | | | | |
| | | | | | | | | reduction | | | | |
| | | | | | Maximum | | | ratio | | | | |
| | | | | | temperature | | | of | | | | |
| | | | | | from | | | rollings | | | | |
| | | | | | completion | | | at | | | | |
| | | | | | of | | | final | | | | |
| | | | | | rough | | | stand | | | | |
| | | | Final | | rolling | | | and | | | | |
| | | | rolling | | to | | | at | Average | | Average | |
| | | | reduction | | descaling | | | one | cooling | | cooling | |
| | | Slab | ratio of | | before | | | stand | rate | | rate | |
| Manu- | | heating | rough | | finish | | Finishing | before | until | Coiling | after | |
| facturing | Steel | temperature | rolling | T1 | rolling | T2 | temperature | final | coiling | temperature | coiling | |
| No. | No. | (° C.) | (%) | (° C.) | (° C.) | (° C.) | (° C.) | stand (%) | (° C./s) | (° C.) | (° C./h) | Note |
| 1 | A | 1245 | 28 | 1119 | 1131 | 830 | 949 | 28 | 48 | 364 | 30 | Example |
| | | | | | | | | | | | | of the |
| | | | | | | | | | | | | present |
| | | | | | | | | | | | | invention |
| 2 | B | 1240 | 27 | 1134 | 1145 | 830 | 948 | 27 | 36 | 429 | 30 | Example |
| | | | | | | | | | | | | of the |
| | | | | | | | | | | | | present |
| | | | | | | | | | | | | invention |
| 3 | B | 1165 | 25 | 1134 | 1140 | 830 | 943 | 28 | 45 | 433 | 25 | Comparative |
| | | | | | | | | | | | | Example |
| 4 | B | 1230 | 35 | 1134 | 1142 | 830 | 877 | 23 | 46 | 367 | 25 | Comparative |
| | | | | | | | | | | | | Example |
| 5 | B | 1245 | 25 | 1134 | 1125 | 830 | 932 | 23 | 35 | 372 | 25 | Comparative |
| | | | | | | | | | | | | Example |
| 6 | B | 1245 | 14 | 1134 | 1145 | 830 | 820 | 25 | 58 | 353 | 25 | Comparative |
| | | | | | | | | | | | | Example |
| 7 | B | 1240 | 25 | 1134 | 1140 | 830 | 967 | 35 | 43 | 430 | 15 | Comparative |
| | | | | | | | | | | | | Example |
| 8 | B | 1240 | 29 | 1134 | 1145 | 830 | 925 | 28 | 20 | 414 | 20 | Comparative |
| | | | | | | | | | | | | Example |
| 9 | B | 1250 | 29 | 1134 | 1152 | 830 | 965 | 22 | 36 | 475 | 20 | Comparative |
| | | | | | | | | | | | | Example |
| 10 | B | 1245 | 25 | 1134 | 1150 | 830 | 948 | 25 | 41 | 320 | 40 | Comparative |
| | | | | | | | | | | | | Example |
| 11 | B | 1245 | 26 | 1134 | 1148 | 830 | 886 | 24 | 5 | 437 | 50 | Comparative |
| | | | | | | | | | | | | Example |
| 12 | B | 1245 | 29 | 1134 | 1148 | 830 | 939 | 26 | 57 | 381 | 10 | Comparative |
| | | | | | | | | | | | | Example |

The underline indicates that conditions are not preferable

TABLE 4

| | | | | | | | | Cumulative | | | | |
|---|---|---|---|---|---|---|---|---|---|---|---|---|
| | | | | | | | | rolling | | | | |
| | | | | | Maximum | | | reduction | | | | |
| | | | | | temper- | | | ratio | | | | |
| | | | | | ature | | | of rollings | | | | |
| | | | | | from | | | at | | | | |
| | | | | | completion | | | final | | | | |
| | | | | | of | | | stand | | | | |
| | | | Final | | rough | | | and | | | | |
| | | | rolling | | rolling | | | at | | | Average | |
| | | | reduction | | to | | | one | Average | | cooling | |
| | | Slab | ratio | | descaling | | | stand | cooling | | rate | |
| | | heating | of | | before | | Finishing | before | rate | Coiling | after | |
| Manu- | | temper- | rough | | finish | | temper- | final | until | temper- | coiling | |
| facturing | Steel | ature | rolling | T1 | rolling | T2 | ature | stand | coiling | ature | (° C./ | |
| No. | No. | (° C.) | (%) | (° C.) | (° C.) | (° C.) | (° C.) | (%) | (° C./s) | (° C.) | h) | Note |
| 13 | C | 1245 | 27 | 1167 | 1183 | 830 | 926 | 25 | 55 | 420 | 30 | Example |
| | | | | | | | | | | | | of the |
| | | | | | | | | | | | | present |
| | | | | | | | | | | | | invention |
| 14 | D | 1245 | 30 | 1170 | 1175 | 830 | 966 | 29 | 65 | 406 | 30 | Example |
| | | | | | | | | | | | | of the |
| | | | | | | | | | | | | present |
| | | | | | | | | | | | | invention |
| 15 | E | 1245 | 30 | 1167 | 1174 | 830 | 965 | 25 | 36 | 449 | 30 | Example |
| | | | | | | | | | | | | of the |
| | | | | | | | | | | | | present |
| | | | | | | | | | | | | invention |
| 16 | F | 1240 | 27 | 1118 | 1123 | 830 | 947 | 27 | 38 | 362 | 20 | Example |
| | | | | | | | | | | | | of the |
| | | | | | | | | | | | | present |
| | | | | | | | | | | | | invention |
| 17 | G | 1240 | 27 | 1166 | 1178 | 830 | 943 | 28 | 47 | 439 | 35 | Example |
| | | | | | | | | | | | | of the |
| | | | | | | | | | | | | present |
| | | | | | | | | | | | | invention |
| 18 | H | 1240 | 28 | 1162 | 1192 | 830 | 902 | 29 | 53 | 406 | 30 | Example |
| | | | | | | | | | | | | of the |
| | | | | | | | | | | | | present |
| | | | | | | | | | | | | invention |
| 19 | I | 1270 | 30 | 1165 | 1175 | 919 | 934 | 27 | 54 | 393 | 30 | Example |
| | | | | | | | | | | | | of the |
| | | | | | | | | | | | | present |
| | | | | | | | | | | | | invention |
| 20 | J | 1250 | 30 | 1107 | 1125 | 1055 | 1072 | 22 | 57 | 427 | 15 | Example |
| | | | | | | | | | | | | of the |
| | | | | | | | | | | | | present |
| | | | | | | | | | | | | invention |
| 21 | K | 1270 | 25 | 1112 | 1120 | 1106 | 1120 | 25 | 51 | 414 | 15 | Example |
| | | | | | | | | | | | | of the |
| | | | | | | | | | | | | present |
| | | | | | | | | | | | | invention |
| 22 | L | 1250 | 30 | 1167 | 1172 | 830 | 911 | 22 | 48 | 375 | 20 | Example |
| | | | | | | | | | | | | of the |
| | | | | | | | | | | | | present |
| | | | | | | | | | | | | invention |
| 23 | M | 1240 | 29 | 1168 | 1180 | 830 | 889 | 0 | 48 | 362 | 25 | Example |
| | | | | | | | | | | | | of the |
| | | | | | | | | | | | | present |
| | | | | | | | | | | | | invention |
| 24 | N | 1245 | 25 | 1111 | 1134 | 830 | 892 | 24 | 65 | 400 | 25 | Example |
| | | | | | | | | | | | | of the |
| | | | | | | | | | | | | present |
| | | | | | | | | | | | | invention |
| 25 | O | 1250 | 25 | 1157 | 1165 | 830 | 878 | 23 | 66 | 372 | 25 | Example |
| | | | | | | | | | | | | of the |
| | | | | | | | | | | | | present |
| | | | | | | | | | | | | invention |
| 26 | P | 1250 | 29 | 1135 | 1140 | 830 | 909 | 22 | 62 | 351 | 20 | Example |
| | | | | | | | | | | | | of the |
| | | | | | | | | | | | | present |
| | | | | | | | | | | | | invention |
| 27 | Q | 1235 | 25 | 1167 | 1182 | 830 | 879 | 22 | 32 | 423 | 20 | Example |
| | | | | | | | | | | | | of the |
| | | | | | | | | | | | | present |
| | | | | | | | | | | | | invention |
| 28 | R | 1200 | 29 | 1151 | 1155 | 830 | 918 | 22 | 36 | 367 | 30 | Compar- |
| | | | | | | | | | | | | ative |
| | | | | | | | | | | | | Example |
| 29 | S | 1240 | 26 | 1159 | 1165 | 830 | 897 | 24 | 56 | 438 | 30 | Compar- |
| | | | | | | | | | | | | ative |
| | | | | | | | | | | | | Example |
| 30 | T | 1210 | 30 | 1164 | 1165 | 830 | 956 | 25 | 38 | 370 | 30 | Compar- |
| | | | | | | | | | | | | ative |
| | | | | | | | | | | | | Example |
| 31 | U | 1240 | 30 | 1110 | 1125 | 830 | 945 | 28 | 49 | 391 | 40 | Compar- |
| | | | | | | | | | | | | ative |
| | | | | | | | | | | | | Example |
| 32 | V | 1250 | 27 | 1122 | 1143 | 830 | 874 | 24 | 40 | 422 | 30 | Compar- |
| | | | | | | | | | | | | ative |
| | | | | | | | | | | | | Example |
| 33 | B | 1250 | 25 | 1134 | 1137 | 830 | 972 | 25 | 31 | 448 | 15 | Example |
| | | | | | | | | | | | | of the |
| | | | | | | | | | | | | present |
| | | | | | | | | | | | | invention |
| 34 | B | 1250 | 20 | 1134 | 1142 | 830 | 945 | 30 | 46 | 352 | 25 | Compar- |
| | | | | | | | | | | | | ative |
| | | | | | | | | | | | | Example |

The underline indicates that conditions are not preferable

TABLE 5

| | | | | | | | Pole | Arithmetic | |
|---|---|---|---|---|---|---|---|---|---|
| | | | | | | | density | average | |
| | | | | | | | of | roughness | |
| | | | | | | | {110}<111> | Ra | |
| | | | | | | | orientation | of | |
| | | | | | | | at | surface | |
| Manu- | | | Retained | Fresh | | | surface | after | Sheet |
| facturing | Steel | Bainite | austenite | martensite | Ferrite | Pearlite | layer region | pickling | thickness |
| No. | No. | (area %) | (area %) | (area %) | (area %) | (area %) | (—) | (μm) | (mm) |
| 1 | A | 85 | 15 | 0 | 0 | 0 | 1.6 | 1.1 | 2.3 |
| 2 | B | 77 | 23 | 0 | 0 | 0 | 1.9 | 1.1 | 2.3 |
| 3 | B | 76 | 24 | 0 | 0 | 0 | 2.4 | 1.6 | 2.6 |
| 4 | B | 84 | 13 | 3 | 0 | 0 | 2.9 | 2.2 | 2.6 |
| 5 | B | 77 | 23 | 0 | 0 | 0 | 1.2 | 2.4 | 2.6 |
| 6 | B | 32 | 13 | 3 | 2 | 0 | 5.5 | 0.8 | 2.6 |
| 7 | B | 86 | 14 | 0 | 0 | 0 | 4.6 | 1.1 | 2.6 |
| 8 | B | 73 | 12 | 3 | 8 | 4 | 2.4 | 1.1 | 2.6 |
| 9 | B | 32 | 4 | 3 | 2 | 9 | 2.7 | 1.1 | 2.6 |
| 10 | B | 56 | 4 | 40 | 0 | 0 | 1.3 | 0.9 | 2.6 |
| 11 | B | 36 | 12 | 52 | 0 | 0 | 2.7 | 1.1 | 2.6 |
| 12 | B | 92 | 3 | 0 | 0 | 5 | 1.2 | 0.8 | 2.3 |

| | Tensile | Uniform | | Critical | |
|---|---|---|---|---|---|
| Manu- | strength | elongation | TS × uEl | bend | |
| facturing | TS | uEl | (MPa · | R/t | |
| No. | (MPa) | (%) | %) | (—) | Note |
| 1 | 1153 | 10.1 | 11645 | 0.87 | Example of the |
| | | | | | present invention |
| 2 | 1194 | 8.9 | 10627 | 0.87 | Example of the |
| | | | | | present invention |
| 3 | 1199 | 9.0 | 10791 | 1.92 | Comparative |
| | | | | | Example |
| 4 | 1242 | 7.8 | 9688 | 1.92 | Comparative |
| | | | | | Example |
| 5 | 1205 | 8.9 | 10748 | 1.92 | Comparative |
| | | | | | Example |
| 6 | 1201 | 7.8 | 9372 | 1.92 | Comparative |
| | | | | | Example |
| 7 | 1182 | 7.9 | 9330 | 1.92 | Comparative |
| | | | | | Example |
| 8 | 975 | 7.7 | 7485 | 1.92 | Comparative |
| | | | | | Example |
| 9 | 1052 | 5.9 | 6207 | 1.15 | Comparative |
| | | | | | Example |
| 10 | 1284 | 5.2 | 6677 | 1.15 | Comparative |
| | | | | | Example |
| 11 | 1276 | 5.1 | 6508 | 1.15 | Comparative |
| | | | | | Example |
| 12 | 1178 | 5.7 | 6715 | 1.15 | Comparative |
| | | | | | Example |

The underline indicates that it is outside the scope of the present invention or property values are not preferable

TABLE 6

| | | | | | | | Pole | | |
|---|---|---|---|---|---|---|---|---|---|
| | | | | | | | density | Arithmetic | |
| | | | | | | | of | roughness | |
| | | | | | | | {110}<111> | Ra | |
| | | | | | | | orientation | of | |
| | | | | | | | at | average | |
| | | | | | | | surface | surface | |
| Manu- | | | Retained | Fresh | | | layer | after | Sheet |
| facturing | Steel | Bainite | austenite | martensite | Ferrite | Pearlite | region | pickling | thickness |
| No. | No. | (area %) | (area %) | (area %) | (area %) | (area %) | (—) | (μm) | (mm) |
| 13 | C | 83 | 12 | 5 | 0 | 0 | 1.5 | 1.0 | 2.9 |
| 14 | D | 87 | 13 | 0 | 0 | 0 | 1.9 | 1.0 | 2.9 |
| 15 | E | 91 | 7 | 2 | 0 | 0 | 2.8 | 0.8 | 2.9 |
| 16 | F | 77 | 23 | 0 | 0 | 0 | 2.1 | 1.0 | 2.9 |
| 17 | G | 86 | 9 | 5 | 0 | 0 | 2.5 | 1.0 | 2.9 |
| 18 | H | 84 | 16 | 0 | 0 | 0 | 2.1 | 0.8 | 2.6 |
| 19 | I | 90 | 10 | 0 | 0 | 0 | 2.8 | 0.9 | 2.6 |
| 20 | J | 85 | 15 | 0 | 0 | 0 | 2.6 | 0.9 | 2.6 |
| 21 | K | 77 | 20 | 0 | 3 | 0 | 2.9 | 1.1 | 2.6 |
| 22 | L | 77 | 23 | 0 | 0 | 0 | 1.9 | 1.1 | 2.9 |
| 23 | M | 75 | 24 | 1 | 0 | 0 | 1.4 | 0.9 | 2.9 |
| 24 | N | 85 | 15 | 0 | 0 | 0 | 1.5 | 0.8 | 2.3 |
| 25 | O | 83 | 17 | 0 | 0 | 0 | 2.6 | 0.9 | 2.0 |
| 26 | P | 81 | 11 | 3 | 5 | 0 | 1.4 | 1.0 | 2.3 |
| 27 | Q | 70 | 21 | 5 | 4 | 0 | 2.7 | 0.9 | 2.3 |
| 28 | R | 74 | 10 | 0 | 12 | 4 | 1.9 | 1.0 | 2.9 |
| 29 | S | 58 | 18 | 24 | 0 | 0 | 2.6 | 0.9 | 2.9 |
| 30 | T | 75 | 3 | 12 | 0 | 10 | 1.3 | 0.8 | 2.9 |
| 31 | U | 83 | 3 | 0 | 12 | 2 | 1.2 | 1.0 | 2.9 |
| 32 | V | 70 | 5 | 25 | 0 | 0 | 2.7 | 0.9 | 2.9 |
| 33 | B | 83 | 10 | 2 | 0 | 5 | 2.5 | 1.1 | 2.9 |
| 34 | B | 84 | 12 | 4 | 0 | 0 | 3.1 | 1.1 | 2.6 |

| | Tensile | Uniform | | Critical | |
|---|---|---|---|---|---|
| Manu- | strength | elongation | TS × uEl | bend | |
| facturing | TS | uEl | (MPa · | R/t | |
| No. | (MPa) | (%) | %) | (—) | Note |
| 13 | 1272 | 6.5 | 8268 | 1.03 | Example of the |
| | | | | | present invention |
| 14 | 1198 | 7.0 | 8337 | 1.03 | Example of the |
| | | | | | present invention |
| 15 | 1136 | 9.1 | 10292 | 1.03 | Example of the |
| | | | | | present invention |
| 16 | 1262 | 8.1 | 10170 | 1.03 | Example of the |
| | | | | | present invention |
| 17 | 1150 | 7.2 | 8281 | 1.03 | Example of the |
| | | | | | present invention |
| 18 | 1198 | 8.2 | 9826 | 1.15 | Example of the |
| | | | | | present invention |
| 19 | 1217 | 7.6 | 9251 | 1.15 | Example of the |
| | | | | | present invention |
| 20 | 1162 | 8.1 | 9412 | 1.15 | Example of the |
| | | | | | present invention |
| 21 | 1187 | 8.7 | 10324 | 1.15 | Example of the |
| | | | | | present invention |
| 22 | 1244 | 8.9 | 11067 | 1.03 | Example of the |
| | | | | | present invention |
| 23 | 1262 | 9.2 | 11615 | 1.03 | Example of the |
| | | | | | present invention |
| 24 | 1207 | 8.1 | 9777 | 0.87 | Example of the |
| | | | | | present invention |
| 25 | 1248 | 8.5 | 10607 | 1.00 | Example of the |
| | | | | | present invention |
| 26 | 1075 | 7.8 | 8385 | 0.87 | Example of the |
| | | | | | present invention |
| 27 | 987 | 9.2 | 9080 | 0.87 | Example of the |
| | | | | | present invention |
| 28 | 968 | 11.2 | 10842 | 1.03 | Comparative |
| | | | | | Example |
| 29 | 1302 | 6.3 | 8203 | 1.03 | Comparative |
| | | | | | Example |
| 30 | 1162 | 5.7 | 6623 | 1.03 | Comparative |
| | | | | | Example |
| 31 | 963 | 12.2 | 11749 | 1.03 | Comparative |
| | | | | | Example |
| 32 | 1292 | 6.1 | 7881 | 1.03 | Comparative |
| | | | | | Example |
| 33 | 1182 | 7.2 | 8510 | 0.86 | Example of the |
| | | | | | present invention |
| 34 | 1250 | 7.5 | 9375 | 1.92 | Comparative |
| | | | | | Example |

The underline indicates that it is outside the scope of the present invention or property values are not preferable

As can be understood from Table 5 and Table 6, in examples of the present invention, hot-rolled steel sheets having high strength, and excellent ductility and bendability were obtained.

On the other hand, in comparative examples, any one or more of the above properties were poor.

### INDUSTRIAL APPLICABILITY

According to the above aspect of the present invention, it is possible to provide a hot-rolled steel sheet having high strength, and excellent ductility and bendability.

1. A hot-rolled steel sheet having a chemical composition comprising, in mass %,
C: 0.100 to 0.350%,
Si: 0.30 to 3.00%,
Mn: 1.00 to 4.00%,
sol. Al: 0.001 to 2.000%,
Si+sol. Al: 1.00 to 5.00%,
P: 0.100% or less,
S: 0.0300% or less,
N: 0.1000% or less,
O: 0.0100% or less,
Ti: 0 to 0.380%,
Nb: 0 to 0.100%,
V: 0 to 0.500%,
Cu: 0 to 2.00%,
Cr: 0 to 2.00%,
Mo: 0 to 1.00%,
Ni: 0 to 2.00%,
B: 0 to 0.0100%,
Ca: 0 to 0.0200%,
Mg: 0 to 0.0200%,
REM: 0 to 0.1000%,
Bi: 0 to 0.020%,
one or more of Zr, Co, Zn and W: 0 to 1.00% in total,
Sn: 0 to 0.050%, and
a remainder comprising Fe and impurities, and
wherein a microstructure comprises, in area %,
bainite: 55 to 95%,
retained austenite: 5 to 30%,
fresh martensite: 5% or less,
ferrite: 5% or less, and
pearlite: 5% or less,
in a texture at a region from a surface to a ⅛ thickness depth from the surface, a pole density of {110}<111> orientation is 3.0 or less, and
an arithmetic average roughness Ra of the surface after pickling is less than 1.2 μm.

2. The hot-rolled steel sheet according to claim 1,
wherein the chemical composition comprises, in mass %, one or more of
Ti: 0.005 to 0.380%,
Nb: 0.005 to 0.100%,
V: 0.005 to 0.500%,
Cu: 0.01 to 2.00%,
Cr: 0.01 to 2.00%,
Mo: 0.01 to 1.00%,
Ni: 0.02 to 2.00%,
B: 0.0001 to 0.0100%,
Ca: 0.0005 to 0.0200%,
Mg: 0.0005 to 0.0200%,
REM: 0.0005 to 0.1000%, and
Bi: 0.0005 to 0.020%.
